(19) United States
(12) Patent Application Publication
(10) Pub. No.: US 2009/0115236 A1
(43) Pub. Date: May 7, 2009

(54) Vehicle Seat Assembly For Use In A Vehicle Having A Removable Panel That Is Stowable On The Seat Assembly And Method Of Making The Same

(75) Inventors: Alan Sturt, West Bloomfield, MI (US); Paul Rye, Brighton, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: International Automotive Components Group North America, Inc., Dearborn, MI (US)

(21) Appl. No.: 11/933,596

(22) Filed: Nov. 1, 2007

(51) Int. Cl. B60N 2/44; B60N 2/20

(52) U.S. Cl. 297/354.1

(57) ABSTRACT

A vehicle seat assembly is disclosed for use in a vehicle having a removable stowable panel. The seat includes a seat body having a seat bottom and a reclinable seat back. A trim component is supported on the seat body and hangs in a downward direction behind the seat body and is free to move in a direction rearward of the seat body. A receiving member is supported by the trim component such that the receiving member is disposed below a bottom portion of the seat back and moves rearward as the trim component moves rearward. The trim component and the receiving member permit the end of the removable panel to move partially away from the seat body as the seat is reclined when the removable panel is stowed on the vehicle seat assembly.

### BACKGROUND OF THE INVENTION

1. Field of the Invention

The field of this invention relates to vehicle seat assemblies for use in vehicles having a removable panel that is configured to be stowed on the vehicle seat assembly. The field of the invention also includes a method of making the same.

2. Background Art

A vehicle seat assembly for use in a vehicle having a removable panel that is configured to be stowed on the vehicle seat assembly is disclosed herein. Examples of vehicle seat assemblies include U.S. Pat. Nos. 6,540,295 and 6,237,994 and U.S. Patent Application Publication No. 2006/0055214.

### SUMMARY OF THE INVENTION

In one aspect of the invention, a vehicle seat assembly for use in a vehicle having a removable panel that is configured to be stowed on the vehicle seat assembly is disclosed. In a first embodiment, the vehicle seat assembly includes a seat body having a seat bottom and a seat back that is configured to recline with respect to the seat bottom. A trim component having a lower end is supported on the seat body such that the lower end is capable of hanging in a generally downward direction behind the seat body. The lower end is free to move in a direction rearward of the seat body with respect to the vehicle. A receiving member that is configured to receive an end of the removable panel is supported by the trim component such that the receiving member is disposed below a bottom portion of the seat back and moves rearward as the trim component moves rearward. The trim component and the receiving member permit the end of the removable panel to move partially away from the seat body as the seat back is reclined when the removable panel is stowed on the vehicle seat assembly and the end is received by the receiving member.

In at least one implementation of the first embodiment, the removable panel may have a first length and the receiving member may be disposed at a first distance from a top portion of the seat back that is at least equal to the first length.

In another implementation of the first embodiment, the removable panel may have a length exceeding a length of the seat back. The receiving member may be disposed at a sufficient distance from a top portion of the seat back such that when the removable panel is stowed and the end is received in the receiving member, the removable panel is substantially disposed below the top portion of the seat back.

In another implementation of the first embodiment, the receiving member includes a pocket configured to receive the end of the removable panel. The pocket may have a width that is generally the same as the width of the removable panel. In at least one variation of this implementation, the receiving portion of the pocket faces generally upwardly to facilitate receiving the removable panel. In a further variation of this implementation, the receiving member may include a spring portion connecting the receiving member to the trim component and flexibly supporting the receiving portion in a generally upward facing direction. In a further variation of this implementation, the receiving member may comprise a plurality of the spring portions and each one of the plurality of the spring portions may be connected to the trim component at a position that is spaced apart from each of the other of the plurality of spring portions.

In another implementation of the first embodiment, the trim component may be a carpet segment and the receiving member may be connected to the carpet segment by stitches.

In another implementation of the first embodiment, the receiving member may be removably attached to the trim component.

In another implementation of the first embodiment, the assembly may further include a means for removably attaching the receiving member to the trim component.

In another implementation of the first embodiment, the trim component may be disposed on the seat back in a position that at least partially conceals a gap between the seat back and the seat bottom.

In another implementation of the first embodiment, the assembly further includes a seat cover covering the seat body and the trim component may be connected to the seat cover. In a variation of this implementation, the trim component may be integral with the seat cover. In a further variation of this implementation, the trim component may be integral with a portion of the seat cover that covers the seat back.

In a second embodiment, a vehicle seat assembly is provided for use in a vehicle having a tub for storing the vehicle seat assembly in a folded state. The vehicle further includes a removable load floor panel to selectively cover the tub when the seat is in a deployed state. The removable load floor panel includes an attachment portion that is configured to be removably attached to the vehicle seat assembly and a docking portion that is disposed opposite the attachment portion. In this second embodiment, the vehicle seat assembly comprises a seat body having a seat bottom, a seat back configured to recline with respect to the seat bottom, and a seat cover covering the seat back. A trim segment having an upper end and a lower end that is disposed opposite the upper end is attached at the upper end to the seat cover proximate a lower portion of the seat back such that the lower end hangs in a generally downward direction below and behind the seat back. The lower end is free to move in a direction rearward of the seat body. A pocket member having a pocket portion that is configured to receive the docking portion is attached to the trim segment such that the pocket member and the trim segment form a tether that permits the removable panel to move partially away from the seat body as the seat back is reclined when the attachment portion of the removable load floor panel is attached to the vehicle seat assembly and the docking portion is received by the pocket portion.

In at least one implementation of the second embodiment, the removable load floor panel may have a length that exceeds a length of the seat back. The pocket member and the trim segment may be configured to retain the removable load floor panel such that the removable load floor panel does not extend above a top portion of the seat back when the attachment portion of the removable load floor panel is attached to the seat back and the docking portion of the removable load floor panel is received within the pocket portion.

In another implementation of the second embodiment, the pocket portion of the pocket member may face generally upwardly to facilitate receiving the removable panel. In a variation of this implementation, the pocket member may include a plurality of spring steel strips wherein each one of the plurality of spring steel strips are connected to the seat back such that each one of the plurality of spring steel strips are spaced apart from each of the other of the plurality of spring steel strips and each one of the plurality of spring steel strips flexibly supports the pocket portion in a generally upwardly facing direction.

In another implementation of the second embodiment, the pocket member may be removably attached to the trim segment.

In another aspect of the invention, a method of making a vehicle seat assembly for use in a vehicle having a removable panel that is adapted to be stowed on the vehicle seat assembly is disclosed. In a third embodiment, the method includes providing a vehicle seat body having a seat bottom and a seat back that is configured to recline with respect to the seat bottom. Also provided is a trim component that is configured to conceal a gap between the seat back and the seat bottom. Further, a receiving member that is configured to receive a docking portion of the removable panel is also provided. The trim component is attached to the seat body such as the trim component is disposed behind the seat body and at least partially conceals the gap between the seat back and the seat bottom and such that an end of the trim component hangs in a generally downward direction. The receiving member is attached to the trim component at a location that is spaced apart from the trim component's connection to the seat body to form a tether that permits the removable panel to partially move in a direction rearward of the seat body when the removable panel is stowed on the vehicle seat assembly.

### BRIEF DESCRIPTION OF THE DRAWINGS

FIG. 1 is a fragmented cut away side elevational schematic view illustrating a vehicle equipped with a vehicle seat assembly having a removable panel stowed on the seat assembly;

FIG. 2A is a fragmented cutaway side elevational schematic view of the vehicle of FIG. 1 with the seat assembly in a reclined configuration;

FIG. 2B is an expanded view of the portion circled in FIG. 2A;

FIG. 3 is a perspective view illustrating a trim component and a receiving member attached thereto;

FIG. 4 is a perspective view of an alternative embodiment of the receiving member of FIG. 3;

FIG. 5 is a cross sectional view of a portion of the vehicle seat assembly of FIG. 1;

FIG. 6 is a fragmented cross-sectional view similar to that of FIG. 5 showing an alternate embodiment of the vehicle seat assembly; and

FIG. 7 is a flow chart illustrating an embodiment of the method of making the vehicle seat assembly of FIG. 1.

### DETAILED DESCRIPTION OF THE PREFERRED EMBODIMENT(S)

Detailed embodiments of the present invention are disclosed herein; however, it is to be understood that the disclosed embodiments are merely exemplary of the invention that may be embodied in various and alternative forms. The figures are not necessarily drawn to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

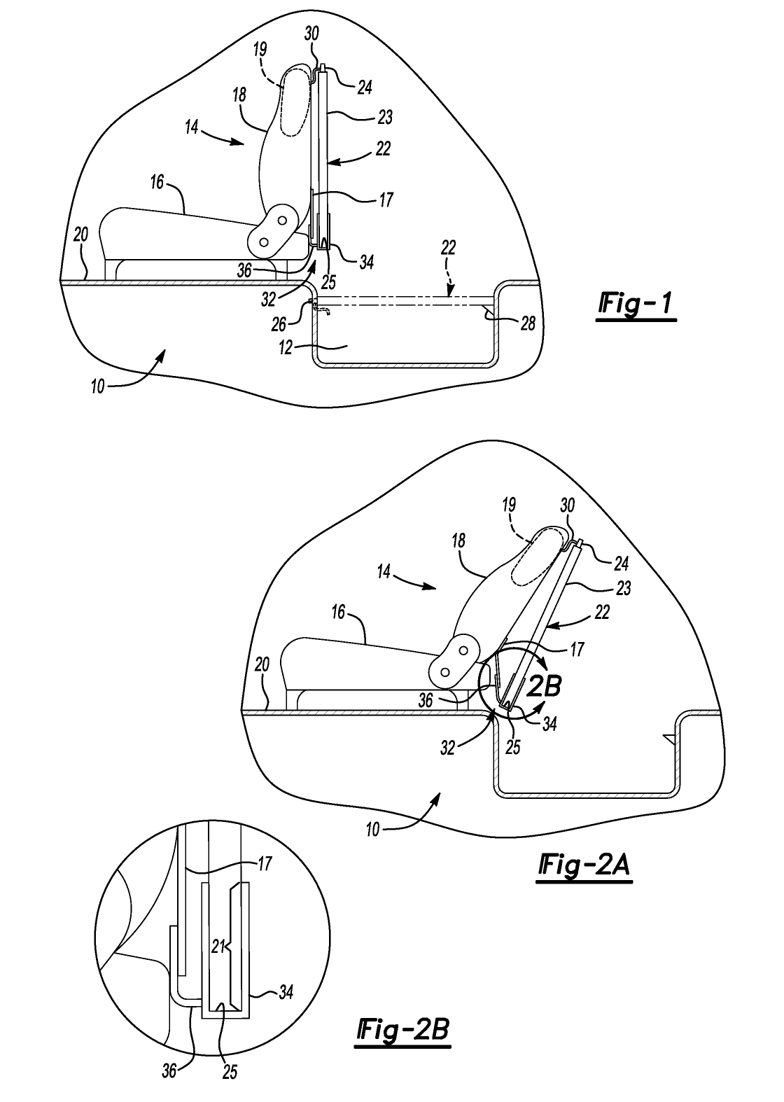

FIG. 1 is a fragmented side elevational cutaway view of a vehicle equipped with an embodiment of the vehicle seat assembly of the present invention. As illustrated, vehicle 10 is a minivan. It should be understood by those of ordinary skill in the art that the teachings of the present invention are applicable to vehicles other than minivans including pickup trucks, sport utility vehicles, passenger sedans, and coupes, to name a few. Further, the teachings of the present invention are not limited to use of automobiles but may be employed on any vehicle including aircraft, water craft, space craft and other type of land vehicles including rail driven vehicles.

Vehicle 10 includes a tub 12 comprising a substantially open recessed area disposed to the rear of seat assembly 14. Seat assembly 14 includes a seat bottom 16 for supporting an occupant while seated. The seat back 18, which is pivotally connected to seat bottom 16, may support the back of a user occupying seat assembly 14. In the illustrated embodiment, seat assembly 14 may also fold flat such that seat back 18 folds forward over and onto seat bottom 16 to present a substantially flat and substantially horizontal upwardly facing surface to receive cargo. With seat back 18 folded onto seat bottom 16, seat assembly 14 may be moved into tub 12 to provide a substantially flat cargo storage area that is substantially aligned and flush with a floor surface 20.

Vehicle 10 is further equipped with a removable panel or load floor surface 22 having a first end 23 and a second end 25. Removable load floor surface 22 can cover tub 12 when seat assembly 14 is deployed, thereby providing a second or additional load floor surface for receiving cargo disposed above and spaced apart from a load floor surface of tub 12. Removable load floor surface 22 is illustrated in a deployed condition in FIG. 1 in phantom lines. In instances where it is desirable to maintain tub 12 in an uncovered state and where it is further desirable to maintain or store removable load floor surface 22 in vehicle 10, removable load floor surface 22 and vehicle seat assembly 14 may each be modified to permit the stowage of removable load floor surface 22 on a back surface of vehicle seat assembly 14. FIG. 1 illustrates an embodiment of such a vehicle seat assembly and further illustrates removable load floor surface 22 in a stowed position substantially adjacent to seat assembly 14. While the illustrated embodiment depicts a removable load floor surface, it should be understood by those of ordinary skill in the art, that the teachings of the present invention apply to the stowage of any type of panel or other removable structure or component adjacent a rear portion of seat assembly 14.

Removable load floor surface 22 includes a support structure 24 which projects outward from first end 23 of removable load floor surface 22 and is configured to dock with support structure receiver 26, which, in the illustrated embodiment, comprises a substantially cylindrical opening conforming to an outer perimeter of substantially cylindrical support structure 24. It should be understood that support structure 24 and support structure 26 need not be substantially cylindrical. Other geometries may be equally effective. For instance, a substantially rectangular support structure 24 may be received within a substantially rectangular support structure receiver 26. Second end 25 rests on ledge 28 when removable load floor surface 22 is deployed to cover tub 12. Removable load floor surface 22 includes an attachment feature 30 to permit the first end to be removably attached to seat back 18. In the illustrated embodiment, attachment feature 30 is a clip made of spring steel which is configured to clip onto a rear portion of seat back 18 proximate recessed headrest 19 (shown in phantom lines). Attachment feature 30 may securely support removable load floor surface 22 on an upper portion of seat back 18 but may permit the second end of removable load floor surface 22 to move in a rearward direction as seat back 18 is reclined. It is desirable to allow second end 25 to move in a direction rearward of seat assembly 14 as seat back 18 is reclined in instances where removable load floor surface 22 extends below a lower end of seat back 18 supported on seat back 18. Such movement may ensure that removable load floor surface 22 does not interfere with the reclining operation of seat back assembly 18.

Seat back assembly 14 further includes a trim component 17 supported adjacent a back portion of seat assembly 14. In the illustrated embodiment, trim component 17 is attached to seat back 18. However, it should be understood that trim component 17 may also be supported on seat bottom 16. In the illustrated embodiment, trim component 17 is a carpet segment which hangs from a lower portion of seat back 18 and which is disposed to substantially conceal a gap between seat back 18 and seat bottom 16 which would otherwise be visible from a rear portion of the vehicle. It should be understood that trim component 18 need not be a carpet segment, but rather, may be any type of component including, without limitation, bars, links and tethers and may be made from any material including, without limitation, metals, plastics, woods and fabrics. In instances where trim component 17 comprises a substantially rigid solid, it may be pivotally connected to seat assembly 14. In instances where trim component 17 comprises a relatively flexible material, such as a fabric, trim component 17 may not be pivotally connected to seat assembly 14.

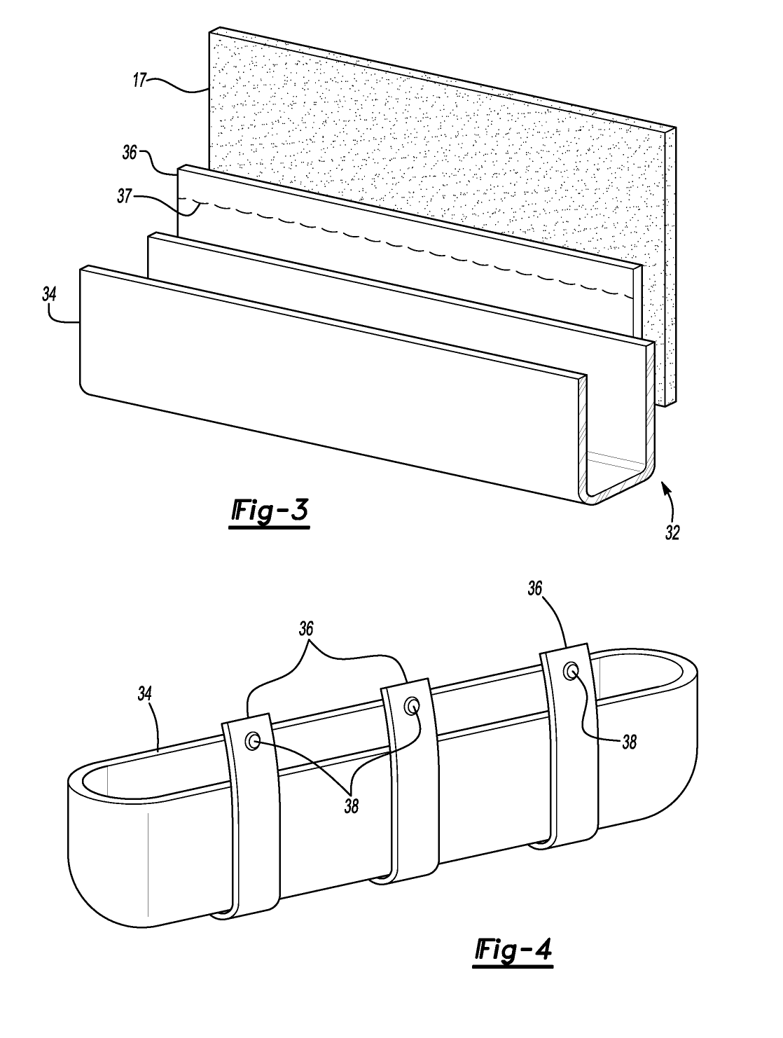

Seat assembly 14 further includes a receiving member 32 including a pocket portion 34 and an attachment portion 36. Pocket portion 34 is configured to receive a docking portion 21 disposed proximate second end 25 of removable load floor surface 22 (See FIG. 2B). A user desiring to attach removable load floor surface 22 to seat assembly 14 would align attachment feature 30 with a top portion of seat back 18 and substantially simultaneously docking portion 21 with the upwardly oriented pocket portion 34 of receiving member 32 and lower removable load floor surface 22 into position such that first end 23 is secured to the top portion of seat back 18 by attachment feature 30 and docking portion 21 is received within and retained by receiving member 32. Alternatively, seat assembly 14 could be configured to allow either attachment feature 30 or docking portion 21 to engage first for ease of installation. Attachment portion 36 is attached to trim component 17 and thus links pocket portion 34 with trim component 17. Attachment portion 36 may be connected to a forward facing portion of trim component 17 (see FIGS. 1 and 2) or a rearward facing portion of trim component 17 (see FIG. 3). In other embodiments, attachment portion 36 may be connected to a bottom portion of trim component 17 (not shown).

As seat back 18 is reclined in the rearward direction, removable load floor surface 22, acting under the force of gravity, would experience a natural tendency to pivot about attachment feature 30 such that second end 25 moves in a rearward direction. Receiving member 32 cooperates with trim component 17 to tether removable load floor surface 22 and to constrain it from swinging freely in an uncontrolled fashion.

FIG. 2A illustrates vehicle 10 of FIG. 1 as seat back 18 is reclined. This Figure depicts how removable load floor surface 22 pivots about attachment feature 30 such that second end 25 moves towards the rear of vehicle 10. This view further illustrates how trim component 17 and receiving member 32 tether second end 25 to prevent it from pivoting rearward beyond a desirable distance.

FIG. 2B is an expanded view of the portion circled in FIG. 2A. In this view, the engagement between docking portion 21 and receiving member 34 is illustrated.

FIG. 3 is a perspective view of trim component 17 and receiving member 32. In the illustrated embodiment, trim component 17 is a carpet segment that is configured to be attached to a rear portion of seat back 18. Attachment portion 36 is, in the illustrated embodiment, a sheet of plastic formed as a spring sheet which may generally retain its shape while also being pliant and flexible in response to the forces exerted by the removable load floor surface 22 as seat back 18 is reclined and as second end 25 moves towards the rear of the vehicle 10. In the illustrated embodiment, attachment portion 36 has been permanently sewn with stitches 37 onto trim component 17 and is not configured or designed to be removed. Attachment portion 36 retains pocket portion 34 in a generally upright configuration so that removable load floor structure 22 may be inserted into pocket portion 34 without the need to separately manipulate pocket portion 34 into a position where it can receive the second end 25. In other embodiments, attachment 36 may have greater flexibility and may permit pocket portion 34 to hang in a generally downward direction, requiring manipulation prior to insertion of second end 25. Attachment portion 36 may be made, without limitation, from materials including polyethylene, polypropylene and nylon. Alternatively, attachment portion 36 may be comprised of metal including any commercially available carbon or stainless spring steel.

Trim component 17, being a carpet segment as illustrated in FIG. 3, is flexible and contributes to seat assembly 14's ability to flexibly retain second end 25 as it moves towards the rear of vehicle 10. In other embodiments, however, trim component 17 may be a substantially rigid component comprised of plastic or metal or, in still other embodiments, comprise a linkage supporting attachment portion 36 and pivoting as seat back 18 reclines. In other embodiments, receiving member 32 may be removably attached to trim component 17 by such means as buttons, snaps, zippers, hook and loop connectors, latches, threaded fasteners, and tongue-in-groove connectors.

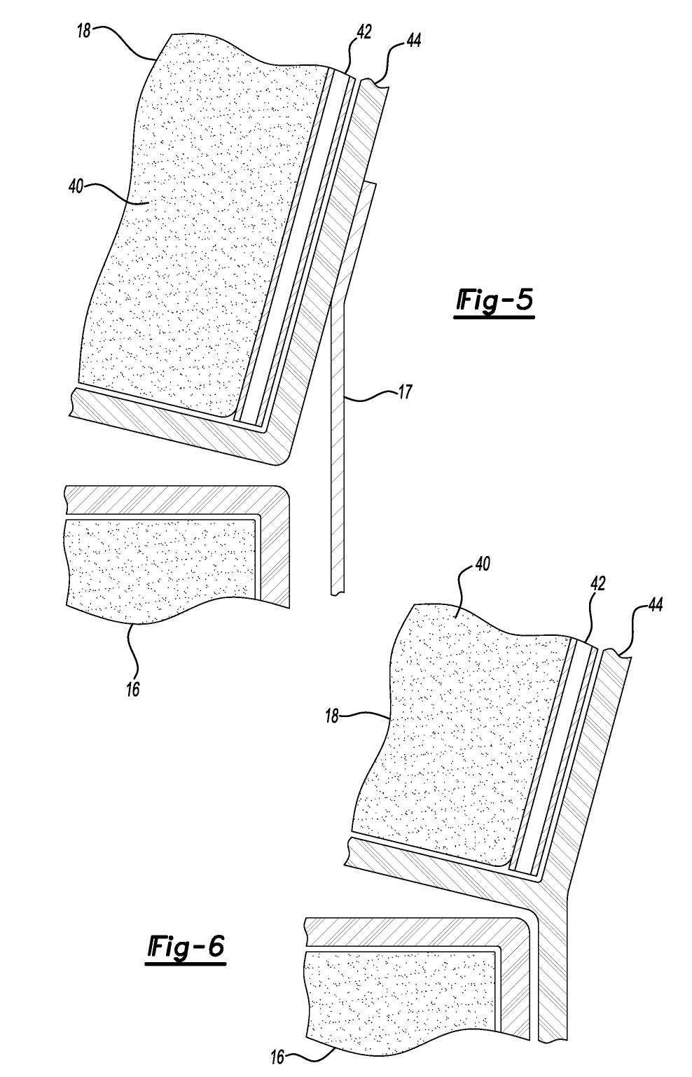

FIG. 4 illustrates an alternative embodiment of receiving member 32. In FIG. 4, a plurality of attachment portions 36 may be utilized as opposed to a single attachment portion. In the embodiment illustrated in FIG. 4, pocket portion 34 is closed on each end. This configuration permits pocket portion 34 to be constructed of flexible materials such as fabric while still being maintained in the generally upward facing orientation. Each attachment portion 36 is fitted with a snap 38 that may be removably attached to a corresponding snap disposed on trim component 17. In other embodiments, pocket portion 34 is constructed of a substantially rigid material.

With reference to FIG. 5, a fragmented cross-sectional view is presented illustrating a portion of seat back 18 including trim component 17. Seat back 18 includes a cushion portion 40 for supporting the back of a seat occupant, a seat frame 42 to provide structural support for cushion 40 and a seat cover 44 to cover substantially all of seat back 18. Seat cover 44 may be made from any of a number of materials including cloth, vinyl or leather. Trim component 17 may comprise a separate component that has been attached to seat cover 44 by stitches or by other attachment means.

FIG. 6 illustrates an alternate embodiment wherein trim component 17 is integral with seat cover 44.

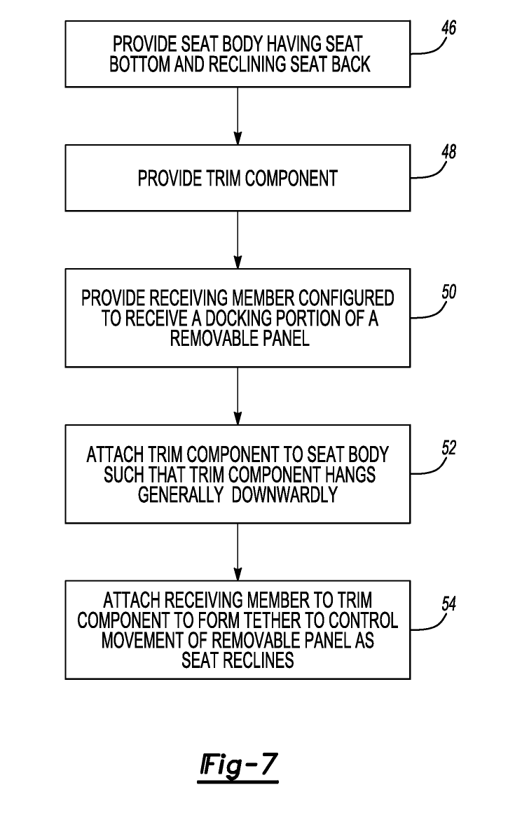

FIG. 7 illustrates a method of making vehicle seat assembly 14 for use in a vehicle 10 having a removable panel such as removable load floor surface 22 that is adapted to be stowed on seat assembly 14. The adaptation includes an attachment portion such as attachment feature 30 and the docking portion 21 proximate end 25. The method includes providing a vehicle seat body having a seat bottom such as seat bottom 16 and a seat back such as seat back 18 that is configured to recline with respect to the seat bottom. Also provided is a trim component such as trim component 17. Also provided is a receiving member such as receiving member 32 that is configured to receive docking portion 21 of the removable panel. Next, attach trim component to the seat body such that the trim component is disposed behind the seat body and such that an end of the trim component hangs in a generally downward direction. See FIG. 7 at reference numeral 52. Next, attach the receiving member to the trim component at a location that is spaced apart from the point where the trim component is attached to the seat body to form a tether that permits the removable panel to partially move in a direction rearward of the seat body when the removable panel is stowed on the vehicle seat assembly. See FIG. 7 at reference numeral 54.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A vehicle seat assembly for use in a vehicle having a removable panel that is configured to be stowed on the vehicle seat assembly, the vehicle seat assembly comprising:
a seat body having a seat bottom and a seat back configured to recline with respect to the seat bottom;
a trim component having a lower end, the trim component being supported on the seat body such that the lower end is capable of hanging in a generally downward direction behind the seat body, the lower end being free to move in a direction rearward of the seat body with respect of the vehicle; and
a receiving member configured to receive an end of the removable panel, the receiving member being supported by the trim component such that the receiving member is disposed below a bottom portion of the seat back and moves rearward as the trim component moves rearward, the trim component and the receiving member permitting the end of the removable panel to move partially away from the seat body as the seat back is reclined when the removable panel is stowed on the vehicle seat assembly and the end is received by the receiving member.

2. The assembly of claim 1, the removable panel having a first length, wherein the receiving member is disposed at a first distance from a top portion of the seat back that is at least equal to the first length.

3. The assembly of claim 1, the removable panel having a length exceeding a length of the seat back, wherein the receiving member is disposed at a sufficient distance from a top portion of the seat back such that when the removable panel is stowed and the end is received in the receiving member, the removable panel is substantially disposed below the top portion of the seat back.

4. The assembly of claim 1 wherein the receiving member comprises a pocket configured to receive the end of the removable panel, the pocket having a width that is generally the same as the width of the removable panel.

5. The assembly of claim 4 wherein a receiving portion of the pocket faces generally upwardly to facilitate receiving the removable panel.

6. The assembly of claim 5 wherein the receiving member includes a spring portion connecting the receiving member to the trim component and flexibly supporting the receiving portion in a generally upward facing direction.

7. The assembly of claim 6 wherein the receiving member comprises a plurality of the spring portions and wherein each one of the plurality of the spring portions is connected to the trim component at a position that is spaced apart from each of the other of the plurality of spring portions.

8. The assembly of claim 1 wherein the trim component is a carpet segment and the receiving member is connected to the carpet segment by stitches.

9. The assembly of claim 1 wherein the receiving member is removably attached to the trim component.

10. The assembly of claim 1 further comprising a means for removably attaching the receiving member to the trim component.

11. The assembly of claim 1 wherein the trim component is disposed on the seat back in a position that at least partially conceals a gap between the seat back and the seat bottom.

12. The assembly of claim 1 further comprising a seat cover covering the seat body wherein the trim component is connected to the seat cover.

13. The assembly of claim 12 wherein the trim component is integral with the seat cover.

14. The assembly of claim 13 wherein the trim component is integral with a portion of the seat cover covering the seat back.

15. A vehicle seat assembly for use in a vehicle having a tub for storing the vehicle seat assembly in a folded state, the vehicle further including a removable load floor panel to selectively cover the tub when the seat is in a deployed state, an attachment portion of the removable load floor panel being configured to be removably attached to the vehicle seat assembly, the removable load floor panel further having a docking portion disposed opposite the attachment portion, the vehicle seat assembly comprising:
a seat body having a seat bottom, a seat back configured to recline with respect to the seat bottom and a seat cover covering the seat back;
a trim segment having an upper end and a lower end disposed opposite the upper end, the carpet segment being attached at the upper end to the seat cover proximate a lower portion of the seat back such that the lower end hangs in a generally downward direction below and behind the seat back, the lower end being free to move in a direction rearward of the seat body; and
a pocket member having a pocket portion configured to receive the docking portion, the pocket member being attached to the trim segment such that the pocket member and the trim segment form a tether that permits the removable panel to move partially away from the seat body as the seat back is reclined when the attachment portion of the removable load floor panel is attached to the vehicle seat assembly and the docking portion is received by the pocket portion.

16. The assembly of claim 15, the removable load floor panel having a length that exceeds a length of the seat back, wherein the pocket member and the trim segment are configured to retain the removable load floor panel such that the removable load floor panel does not extend above a top portion of the seat back when the attachment portion of the removable load floor panel is attached to the seat back and the docking portion of the removable load floor panel is received within the pocket portion.

17. The assembly of claim 15 wherein the pocket portion of the pocket member faces generally upwardly to facilitate receiving the removable panel.

18. The assembly of claim 17 wherein the pocket member comprises a plurality of spring steel strips, wherein each one of the plurality of spring steel strips are connected to the seat back such that each one of the plurality of spring steel strips are spaced apart from each of the other of the plurality of spring steel strips and wherein each one of the plurality of spring steel strips flexibly supports the pocket portion in a generally upwardly facing direction.

19. The assembly of claim 15 wherein the pocket member is removably attached to the trim segment.

20. A method of making a vehicle seat assembly for use in a vehicle having a removable panel that is adapted to be stowed on the vehicle seat assembly, such adaptation including an attachment portion and a docking portion, the method comprising:
providing a vehicle seat body having a seat bottom and a seat back configured to recline with respect to the seat bottom;
providing a trim component;
providing a receiving member configured to receive a docking portion of the removable panel;
attaching the trim component to the seat body such that the trim component is disposed behind the seat body such that an end of the trim component hangs in a generally downward direction;
attaching the receiving member to the trim component at a location spaced apart from the trim component's attachment to the seat body to form a tether that permits the removable panel to partially move in a direction rearward of the seat body when the removable panel is stowed on the vehicle seat assembly.
